(19) United States
(12) Patent Application Publication
(10) Pub. No.: US 2006/0175951 A1
(43) Pub. Date: Aug. 10, 2006

(54) Electrode for a cold cathode fluorescent lamp and a manufacturing method thereof

(76) Inventor: Luk-Shan Wong, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,892

(22) Filed: Feb. 9, 2005

(51) Int. Cl. H01J 1/14; H01J 9/12

(52) U.S. Cl. 313/311; 445/46

(57) ABSTRACT

An electrode of a cold cathode fluorescent and manufacturing method thereof has an integral structure that makes it easy to increase the discharge area of the discharge portion and raise production output. The manufacturing method of the electrode has the followed steps: mixing metal powders and binders to form a mixture; shaping the mixture in an electrode die to form an electrode mold base; heating the electrode mold base until a sintering temperature to form an electrode; and compacting the electrode for increasing its intensity.

### BACKGROUND OF THE INVENTION

1. Field of the Invention

The present invention relates to an electrode for a cold cathode fluorescent lamp and a manufacturing method thereof, and particularly relates to an electrode for a cold cathode fluorescent lamp with an integral structure, which is made using powder metallurgy technology and injection molding technology.

2. Description of the Prior Art

Cold cathode fluorescent lamps (CCFL) have many advantages, such as a fine tube, a low tube temperature, high surface illumination, and a long life span. As such, they are often used in scanners, facsimile machines, backlight modules for LCDs, and advertising boxes. A CCFL works by discharging from electrodes in the CCFL, and releases electronics from the electrode, impacting the mercury atoms in the lamp tube. The mercury atoms are excited and radiate out ultraviolet light, the ultraviolet light then excites the fluorescent powder on the inner wall surface of the CCFL to produce visible light.

To improve the life span of a CCFL and its characteristics when it is initially turned on, the electrode is the crucial element. Please refer to FIG. 1, which illustrates a cross-sectional view of a cold cathode fluorescent lamp according to the prior art. The CCFL has a lamp tube 8 and a pair of electrodes 9 which are mounted in two ends of the lamp tube 8′. Each electrode 9 has a wire portion 92 and a cup-shaped discharging portion 94. The wire portion 92 is welded with the discharging portion 94. The wire portion 92 usually consists of two sections. A first section 922 is used for connecting with the discharging portion 94, and a second section 924 connects the first second 922 to a conductive wire. The first section 922 is made of a low CTE (coefficient of thermal expansion) alloy for binding easily with the glass tube 8, and a Kovar alloy (an alloy of Nickel, Cobalt and Iron) is used conventionally. The second section 924 is usually an Invar alloy (an alloy of 35% Nickel, and 65% Iron). The cup-shaped discharging portion 94 is usually made by impacting a metal plate of molybdenum alloy or tungsten alloy. The electrode of the prior art mentioned above has the following disadvantages:

1. The diameter of the wire portion 92 is small (about 0.4 mm), and is not easily melted with the cup-shaped discharging portion 94. It is hard to manufacture and cracks easily.

2. The cup-shaped discharging portion 94 is limited by the manufacturing method. The shape is uniform and is not easily changed when an increase in the discharging area is desired. The costs are high, and the product output is low.

The inventor, after investigation and research, thus provides the present invention of logical design for improving the above-mentioned imperfections.

### SUMMARY OF THE INVENTION

An objective of the present invention is to provide an electrode for a cold cathode fluorescent lamp and manufacturing method thereof that is formed integrally with one identical material for raising the production output thereby making the electrode more solid and rigid. The structure of the electrode is more durable than that of the prior art, avoiding metal fatigue, which is caused by different CTEs, and expanding and contracting less during temperature fluctuations, thereby increasing the tube's life span.

Another objective of the present invention is to provide an electrode for a cold cathode fluorescent lamp and a manufacturing method thereof that makes it easy to design the shape of the electrode to increase the discharging area, raising efficiency and reducing electrical waste.

In order to achieve the above objectives, the present invention provides a manufacturing method for an electrode for a cold cathode fluorescent lamp comprising of the following steps: first, metal powders and binders are mixed; the mixture is shaped in an electrode die to form an electrode mold base; then, the electrode mold base is heated until a sintering temperature forms an electrode; finally, the electrode is impacted more solidly.

### BRIEF DESCRIPTION OF THE DRAWINGS

The invention will be better understood and objectives other than those set forth above will become apparent when consideration is given to the following detailed description thereof. Such description makes reference to the annexed drawings, wherein:

FIG. 1 is a cross-sectional view of a cold cathode fluorescent lamp according to the prior art;

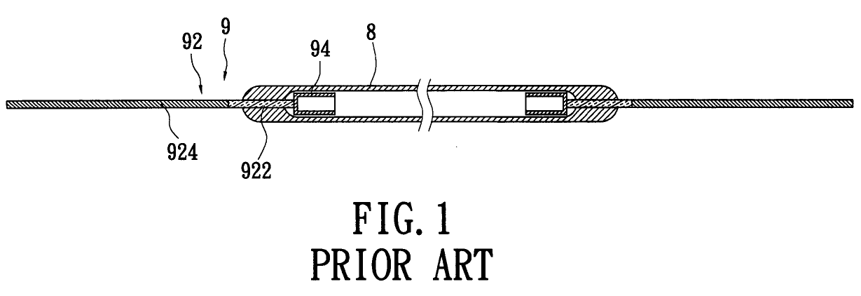

FIG. 2 is a flowchart for a manufacturing method for an electrode for a cold cathode fluorescent lamp according to the present invention;

FIG. 3 is a perspective view of an electrode for a cold cathode fluorescent lamp according to a first embodiment of the present invention;

FIG. 4 is a perspective view of an electrode for a cold cathode fluorescent lamp according to a second embodiment of the present invention; and

FIG. 5 is a perspective view of an electrode for a cold cathode fluorescent lamp according to a third embodiment of the present invention.

### DESCRIPTION OF THE PREFERRED EMBODIMENT

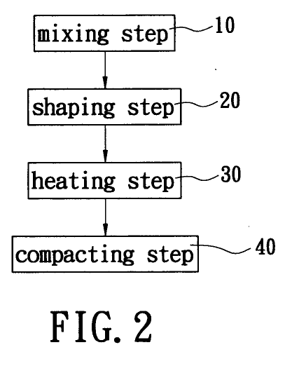

Please refer to FIG. 2, which illustrates a flowchart of a manufacturing method for an electrode for a cold cathode fluorescent lamp according to the present invention. The kernel technology used in the manufacturing method for the electrode for a cold cathode fluorescent lamp (CCFL) comprises of at least four steps: a mixing step 10, a shaping step 20, a heating step 30, and a compacting step 40.

In the mixing step 10, metal powders and binders are combined to form a mixture. The metal powders are preferably made of metals with high melting points, usually over 2000 degrees centigrade, such as tungsten (W), molybdenum (Mo), a tungsten alloy, a molybdenum alloy, or a Kovar alloy (pre-alloyed powder is better, which lowers uneven dispersion). Such metals have high melting points and can endure high temperatures. Of the above metals, molybdenum metal powder is preferred, because the melting temperature of tungsten is higher and therefore a higher heating temperature is required, which would raise the costs of production. However the metal powder is not limited to the above described metals, and it is all right if the metal can be used as an electrode.

The metal powder is more smaller, and the sintering process is better. It is preferable that the metal powder diameter is under above 80 μm, but it is not limited. The smaller the metal powder is, the more surface area it has, and the space between the grains of the powder is smaller. Therefore the metal powder is closer and more solid, and it is easily sintered together so that the time required for the heating step 30 is reduced. The size of the metal powder influences not only the density of the sintered product, but also the performance. If the metal powder is smaller, the specific surface area (area/weight) will be higher. Having a high specific surface area is very important during the sintering process. The binder is used chiefly for binding the metal powder, and can be a macromolecular binder, or an organic binder (such thermoplastic gum, or wax).

The mixing step 10 further comprises a step of providing a mixing machine to blend the mixture. Blending the metal powders and the binders under heat produces the mixture as a shaping material.

In the shaping step 20, the present invention chiefly utilizes injection molding technology, and injects the mixture into an electrode die to be shaped into an electrode mold base. During injection molding, an injection-molded machine is provided, and comprises a per-heating step for heating the mixture so that it becomes malleable, so that the mixture can then be injected into the electrode die. Because the injection molding technology is a mature technology, it accelerates the production speed.

The present invention is not limited to the injection molding technology, for example, it can utilize shaping technology by pressure. This is done by first, putting the prepared mixture into a precise mold, pressure is then exerted onto the mold by a punch machine to obtain a pressed-powder model (an initial electrode mold base).

In the heating step 30, the main process is heating the electrode mold base until a sintering temperature is reached so that the electrode of the final product can be formed. During the heating process, the binder (or nonmetallic components) will be expelled from the electrode mold base by heating to avoid intermixing any residual binder. In the heating step 30, a sintering furnace is provided preferably to sinter the electrode mold base metallurgically. The sintering furnace usually has a computer to control temperature and air pressure therein, and propel in a protective gas, such as nitrogen, so that the metal powder does not oxidize. The sintering temperature is usually higher than two thirds of the metals melting point. In other words, the range of the sintering temperature can be between two thirds of the melting point and the melting point of the main component. For example, the melting point of tungsten is 3380 degrees centigrade so the sintering temperature should be about 2253 degrees centigrade or higher; the melting point of molybdenum is 2600 degrees centigrade and the sintering temperature should be about 1733 degrees centigrade or higher.

For increasing the structure intensity of the electrode, the present invention also has a compacting step for compacting the electrode, so that the sintered metal powders among the electrode are more compact and solid.

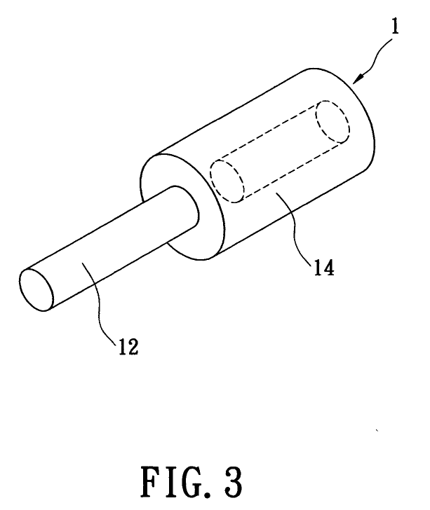

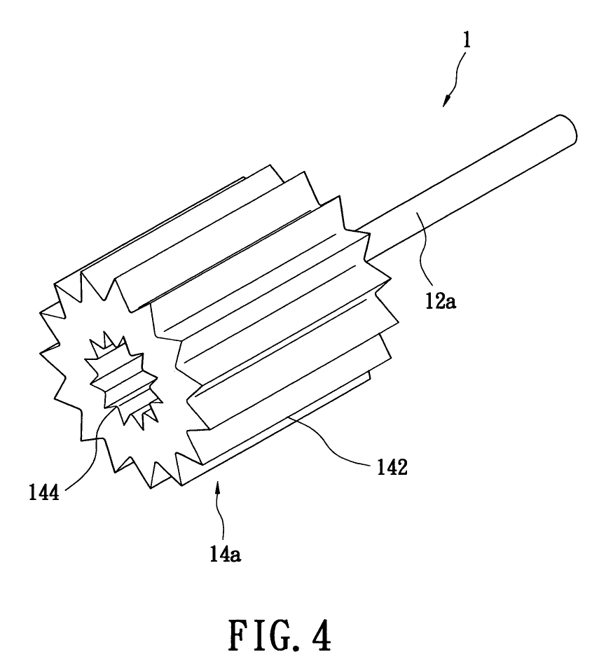

Through the above-mentioned steps, an electrode of the present invention is provided which utilizes the technology of metal powder injection molding and powder metallurgy. According to the technology of the present invention, the shape of the electrode of the CCFL is easily changed so that its discharge area can be increased. Please refer to FIG. 3, which illustrates a perspective view of an electrode for the CCFL according to a first embodiment of the present invention. The electrode 1 of the CCFL comprises a wire portion 12 and a discharging portion 14. The discharging portion 14 is substantially cup-shaped and is formed integrally with the wire portion 12. The wire portion 12 and the discharging portion 14 are made of one identical metal with a metal sintering structure, so that it does not need to be melted together. No cracking between the wire portion 12 and the discharging portion 14 will occur, so the structure is stronger. Pleaser refer to. FIG. 4, which illustrates a perspective view of an electrode of the CCFL according to a second embodiment of the present invention. By utilizing the manufacturing method of an electrode of the CCFL of the present invention, the discharge area of the electrode 1 is increased. A discharge portion 14a having a plurality of tips 142 and 144 protruded from surfaces thereof for increasing the discharge area is also provided which is easy to design. In FIG. 4, the tips 142 and 144 are protruded both from an outside periphery and an inner surface of the discharge portion 14a. The discharge portion 14a has only the tips 142 protruding outwardly from an outside periphery of the discharging portion 14a, or only the tips 144 protrude inwardly from an inside surface of the discharging portion 14a.

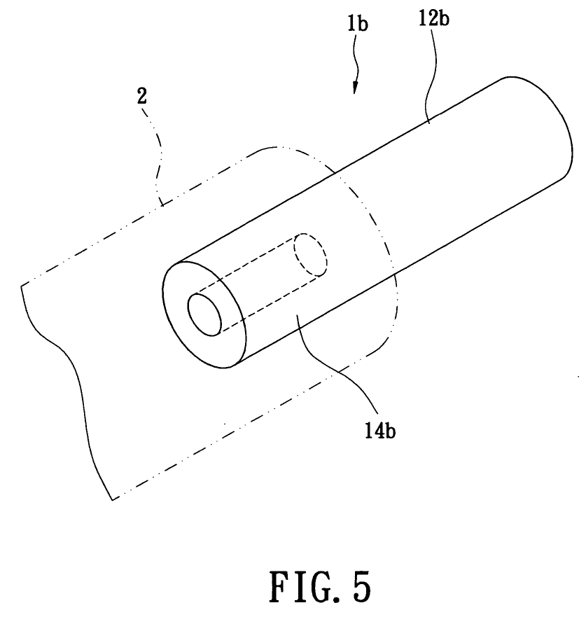

Please refer to FIG. 5, which illustrates a perspective view of an electrode of the cold cathode fluorescent lamp according to a third embodiment of the present invention. This embodiment provides a discharging portion 14b having a diameter equal to that of the wire portion 12b, so that the discharging portion 14b has a stronger structure.

A summary of the characteristics and advantages of the present invention are as follows:

1. The wire portion and the discharging portion of the electrode are formed integrally by sintering them together, so that it is not easily broken.

2. The wire portion and the discharging portion of the electrode are made of one identical metal, so their coefficients of thermal expansion are the same, so that the rapid temperature-change of the electrode will not cause cracks to occur.

3. It is easy to change the shape of the discharge portion to increase the size the discharge area, thereby raising efficiency, and lowering power consumption.

4. The manufacturing method of the present invention can produce the electrode of a CCFL quickly thereby raising output.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A manufacturing method for an electrode for a cold cathode fluorescent lamp, comprising the steps of:
mixing metal powders and binders to form a mixture;
shaping said mixture in an electrode die to form an electrode mold base;
heating said electrode mold base to a sintering temperature and an electrode is formed; and
compacting the electrode.

2. The manufacturing method as claimed in claim 1, wherein said metal powders are made of metals with a melting point over 2000 degrees centigrade.

3. The manufacturing method as claimed in claim 1, wherein said metal powder is tungsten, molybdenum, tungsten alloy, or molybdenum alloy.

4. The manufacturing method as claimed in claim 1, wherein said binder is a macromolecular binder, or an organic binder.

5. The manufacturing method as claimed in claim 1, wherein said mixing step comprises a step of providing a mixing machine to blend said mixture.

6. The manufacturing method as claimed in claim 1, wherein said shaping step comprises a step of per-heating said mixture to a malleable condition.

7. The manufacturing method as claimed in claim 6, further comprising a step of providing an injection molded machine to inject said mixture into the electrode die.

8. The manufacturing method as claimed in claim 1, further comprising a step of expelling nonmetallic components from said electrode mold base.

9. The manufacturing method as claimed in claim 1, further comprising a step of providing a sintering furnace to sinter said electrode mold base metallurgically.

10. The manufacturing method as claimed in claim 9, further comprising a step of guiding a protective atmosphere into said sintering furnace.

11. The manufacturing method as claimed in claim 1, wherein a range of said sintering temperature is between two thirds of the melting point and the melting point of a main component.

12. An electrode of a cold cathode fluorescent lamp, formed by metallic powder metallurgical injection molding, comprising:
a wire portion; and
a discharging portion, being substantially cup-shaped and formed integrally with said wire portion, wherein said wire portion and said discharging portion are made of one identical metal with a metal sintering structure.

13. The electrode of the cold cathode fluorescent lamp as claimed in claim 12, wherein said discharging portion has a plurality of tips protruded from surfaces thereof.

14. The electrode of the cold cathode fluorescent lamp as claimed in claim 13, wherein said tips are protruding outwardly from an outside periphery of said discharging portion.

15. The electrode of the cold cathode fluorescent lamp as claimed in claim 13, wherein said tips are protruding inwardly from an inside surface of said discharging portion.

16. The electrode of the cold cathode fluorescent lamp as claimed in claim 13, wherein said tips are protruding from an outside periphery and an inside surface of said discharging portion.

17. The electrode of the cold cathode fluorescent lamp as claimed in claim 12, wherein said discharging portion has a diameter equal to that of said wire portion.
